(19) United States
(12) Patent Application Publication
(10) Pub. No.: US 2018/0079154 A1
(43) Pub. Date: Mar. 22, 2018

(54) METHOD FOR MANUFACTURING A COMPONENT FROM COMPOSITE MATERIAL

(71) Applicant: Airbus Operations S.A.S., Toulouse (FR)

(72) Inventors: Philippe Moricet, Le Pellerin (FR); Jago Pridie, Nantes (FR)

(73) Assignee: Airbus Operations S.A.S., Toulouse (FR)

(21) Appl. No.: 15/700,516

(22) Filed: Sep. 11, 2017

(30) Foreign Application Priority Data
Sep. 20, 2016 (FR) 16 58812

(51) Int. Cl. B29C 70/44; B29C 70/54; B29C 70/34; B29C 43/12

(52) U.S. Cl. CPC B29C 70/44; B29C 70/541; B29C 2791/006; B29C 70/342; B29C 43/12; B29C 70/543

(57) ABSTRACT

A method for manufacturing a composite component from a plurality of plies of fibres embedded in a resin includes the following steps: forming a preliminary composite component by draping the plurality of fibre plies in a mould; laying up the preliminary composite component by stacking layers comprising at least one airtight film, a drainage fabric and a cover sheet; polymerizing the preliminary composite component arranged on a table of an enclosure of an apparatus of the autoclave type, equipped with a device for measuring the temperature T inside the enclosure, by applying a temperature cycle and a pressure cycle; demoulding a raw composite component; testing the dimensions and defect rate of the raw component, wherein the polymerization step includes the application of a pressure P in the enclosure as soon as the temperature T in the enclosure is greater than or equal to a threshold temperature Ts.

### FIELD OF THE INVENTION

The present invention relates to a method for manufacturing a component from composite material, with the aim of limiting the edge effects.

A component made of composite material is formed of fibres embedded in a resin matrix.

### BACKGROUND OF THE INVENTION

According to a known configuration, shown in FIG. 1, a component made of composite material may be made from a fibrous reinforcer (which may be made of carbon, aramid, or any other suitable material) pre-impregnated with resin (epoxy or polyester or similar). In a first stage, called the draping stage, the pre-impregnated plies are arranged on a counter-shape to form a preliminary component 1, called a preform or blank. The preliminary component 1 may then be pre-consolidated in a vacuum, in an optional step called the compaction step. In a following stage, called the lay-up stage, the preliminary component 1 is arranged on a tool 2. A seal 3 wrapped in a drainage fabric 4 is arranged around the preliminary component 1 before it is gripped between a first and a second set of wedges and covered with a stack 5 of films (called the lay-up).

The lay-up comprises:
a piece of release fabric 5a, arranged only on the preliminary component 1,
an airtight film 5b covering the release fabric 5a, the seal 3a wrapped in drainage fabric 4 and the first set of wedges 6, called the edging wedges, arranged on a grid 7 made of Teflon®,
a drainage fabric 5c covering the airtight film 5b and the second set of wedges 8, called the clamping wedges, arranged under the grid 7, and
a cover sheet 5d, also called a “bladder”, covering the assembly and fixed to seals 9 to ensure the air-tightness of the lay-up.

During a third stage, called the polymerization stage, the laid-up preliminary component 1 is arranged in an evacuated enclosure and subjected to a temperature and pressure cycle so as to be consolidated and to form what is called a raw component (not shown) made of composite material.

Conventionally, this temperature and pressure cycle comprises a first temperature increase of the ambient temperature to a first temperature level and a second temperature increase to a second temperature level. The final stage of the polymerization is the cooling of the resulting component to a minimum demoulding temperature. The pressure is applied from the first temperature increase until the end of the cycle.

After polymerization, the raw component is demoulded and tested (for the defect rate, surface condition and dimensions).

Conventionally, testing a raw component comprises a measurement of the various dimensions (width, length, thickness in the centre and at the edges) of the composite component, together with a measurement of the defect rate, carried out by an NDT (for “Non-Destructive Testing”) method, using an ultrasound apparatus for example (according to a method as described in the document FR1459875).

The polymerization of a component made of composite material formed of fibres embedded in a resin matrix may give rise to a phenomenon called the “edge effect”, which characterizes a component in which the thickness at the periphery is below the desired thickness. This phenomenon is caused by the creep of the resin during polymerization when the resin is compacted by the application of the pressure.

The peripheral area affected by the edge effect may be larger or smaller, depending on the dimensions of the component made of composite material, the nature of the resin and the polymerization method used.

To comply with the assembly tolerances, it is often necessary to add a step of machining the raw component to produce a finished composite component with the desired dimensions. This step is intended to eliminate the peripheral area, and retain only the central portion of constant thickness.

It is therefore essential to drape a preliminary component 1 having greater dimensions than the desired dimensions of the finished composite component, to allow for the machining step.

This edge effect phenomenon therefore has a considerable effect on the final cost of the component (because of the draping time, the loss of material, and the supplementary machining step).

The document FR2961739 proposes a method for producing a composite component, with the aim of limiting the edge effects. This method comprises a pre-polymerization step of adding pre-impregnated plies at the periphery of the composite preform 1 in order to compensate for the variation in thickness due to the edge effect phenomenon. This method requires a knowledge of the surface area of the affected peripheral area, in order to determine the number of plies to be added. If the number of pre-impregnated plies is too low or too high, the step of machining the polymerized preform will still be necessary. This method is costly in terms of time and raw materials.

### BRIEF SUMMARY OF THE INVENTION

The present invention proposes a method for manufacturing a component from composite material which does not have the drawbacks of the prior art.

For this purpose, the present invention is a method for manufacturing a composite component from a plurality of plies of fibres embedded in a resin, the method comprising the following steps:
forming a preliminary component by draping the plurality of fibre plies in a mould;
laying up the preliminary component;
polymerizing the preliminary component arranged in an enclosure equipped with a device for measuring the temperature T inside the enclosure;
demoulding the preliminary component;
testing the dimensions and defect rate.

The method according to an aspect of the invention is remarkable in that the polymerization step comprises the application of a pressure P in the enclosure as soon as the temperature T is greater than or equal to a predetermined threshold temperature.

Thus the pressure is applied to the preliminary component when the viscosity of the resin is at a level higher than the viscosity level at which the pressure is applied in the prior art method. This level of viscosity makes it possible to reduce the effect of the pressure on the resin and hence to reduce the phenomenon called the “edge effect”.

Advantageously, the lay-up step of the method according to the invention comprising the following sub-steps of laying a release fabric and edging wedges, an airtight film, a set of clamping wedges, a drainage fabric and a cover sheet on the preliminary component, the method also comprises the following preliminary sub-steps:
laying a piece of release fabric on a free face and on the edges of the preliminary component, the dimensions of the release fabric being greater than the dimensions of the preliminary component, so that the release fabric covers the whole of the free face, the whole of the edges of the preliminary component, and a portion of the table; and
arranging a set of edging wedges on the portion of the piece of release fabric that covers the table of the tool.

Preferably, the threshold temperature of the method according to an aspect of the invention is determined by a reference table, allowing for the critical dimensions of the composite component and the specified defect rate of said composite component.

According to a variant embodiment, the preliminary component is subjected to a pre-consolidation step in a vacuum, called compacting, before the lay-up step.

According to yet another variant embodiment, a range of test temperatures is defined by measurements of the shrinkage of the material (due to evacuation of the air trapped in the draping step) according to the temperature cycle used.

### BRIEF DESCRIPTION OF THE DRAWINGS

The aforementioned characteristics of the invention, as well as others, will be more fully apparent from a perusal of the following description of an exemplary embodiment, said description being provided in relation to the attached drawings, of which:

FIG. 1, described above, is a diagram of a step of a method for manufacturing a composite component according to the prior art,

FIG. 2 is a view illustrating the steps of a method for manufacturing a composite component according to the invention,

FIG. 3 is a diagram illustrating a detail of a step of the method according to the invention, and

FIG. 4 is a view illustrating a procedure for executing a step of the method according to the invention.

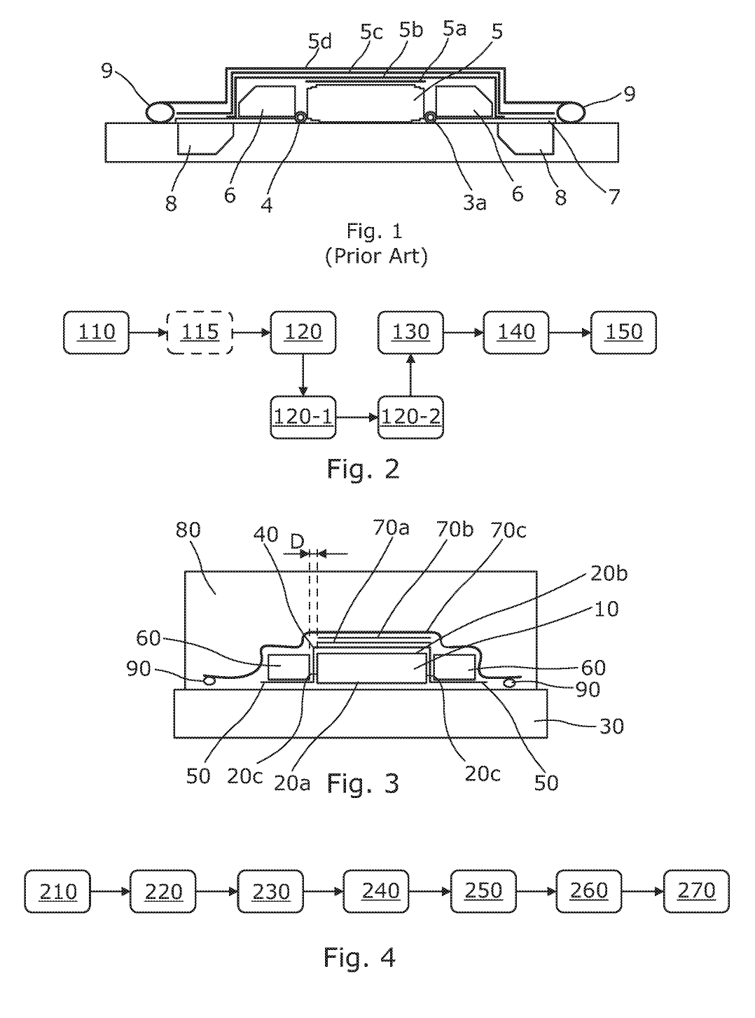

### DETAILED DESCRIPTION

FIG. 2 represents a method 100 for manufacturing a composite component (not shown) according to an aspect of the invention. The method 100 comprises a first step 110 of draping a plurality of plies of fibres (of carbon or aramid, for example), which are pre-impregnated (with an epoxy or polyester resin, for example), on a counter-shape, in order to form a preliminary component 10. This step 110 is identical to the prior art draping step, and will not be described further.

According to a variant embodiment, the method comprises a compaction step 115, identical to the compaction step described in the prior art.

The method 100 comprises a step 120 of laying up the preliminary component 10. In the lay-up step 120, illustrated in FIG. 3, the preliminary component 10 is arranged with one of its faces, called the contact face 20a, on a table 30, and is covered on a free face 20b, opposite the contact face 20a, with a set of films.

The lay-up step 120 comprises a first lay-up sub-step 120-1 in which a piece of release fabric 40 (such as Dry peel ply for general application, 60 BR, marketed by Tygavac®) is laid on the free face 20a and on the edges 20c of the preliminary component 10. As illustrated in FIG. 3, the dimensions of the piece of release fabric 40 are greater than the dimensions of the preliminary component 10, so that the periphery of the piece of fabric covers the whole of the free face 20b and the whole of the edges 20c of the preliminary component 10, and covers a portion 50 of the table 30 of the tool.

The lay-up step 120 comprises a second lay-up sub-step 120-2 which consists in arranging a set of edging wedges 60 on the portion 50 of the piece of release fabric 40 that covers the table 30. The edging wedges 60 are thus positioned at a distance D from the edges 20c of the preliminary component 10 covered with release fabric 40. The distance D is determined on the basis of the expansion of the wedge in the polymerization cycle, so that the edging wedge 60 lies flush with the edge 20c during polymerization.

The lay-up step 120 also comprises the sub-steps, already described in the prior art, which consist in successively arranging a perforated fabric 70a, a set of clamping wedges (not shown), then a drainage fabric 70b, and finally a cover sheet 70c fixed to the table 30 by seals 90 formed with mastic, for example, on the assembly formed by the preliminary component 10, the release fabric 40 and the edging wedges 60.

The method 100 according to an aspect of the invention comprises a step 130 of polymerizing the preliminary component 10 arranged in an enclosure 80 of an apparatus of the autoclave type. Such an enclosure 80 is equipped with a device for measuring the temperature T inside the enclosure 80.

This polymerization step 130 comprises a temperature and pressure cycle, applied to the preliminary component 10 present in the enclosure 80. This temperature cycle is identical to that of the prior art.

In the method 100 according to an aspect of the invention, a pressure P is applied to the preliminary component 10 as soon as the temperature T inside the enclosure 80 has reached a threshold value Ts.

The method 100 according to an aspect of the invention also comprises a step 140 of demoulding the preliminary component 10, which has become the raw component, and a step 150 of testing the raw component 10. These steps 140 and 150 are identical to the demoulding and testing steps executed in the prior art, and will not be described further.

According to an aspect of the invention, the threshold temperature Ts is determined by comparing the creep behaviour of the resin with the value of the defect rate Vd required for a specified use of the composite component.

Thus the threshold temperature Ts is determined, using a press tool (such as a mechanical or hydraulic press, for example), having a table equipped with a heating means, a force sensor and thermocouples, by means of the following steps, as illustrated in FIG. 4:
a step 210 of forming a reference preliminary component 10, identical to the preliminary component 10,
a step 220 of applying a pressure identical to the pressure of the polymerization cycle to the reference preliminary component 10,
a step 230 of raising the temperature of the reference preliminary component 10,
a step 240 of measuring the viscosity and temperature of the reference preliminary component 10; the viscosity is measured, for example, via the force exerted by the resin of the preliminary component 10 on the force sensor,
a step 250 of determining a range of temperature values for which the resin creeps; that is to say, the values in a range between a temperature T1 from which the measured viscosity decreases and a temperature T2 from which the measured viscosity is stabilized at a value called the plateau value,
a step 260 of forming a plurality of reference components PR₁ . . . PRₙ according to steps 110 to 140 described above, for which, in the polymerization step 130, the pressure is applied as soon as the temperature of the enclosure 80 reaches a reference temperature TRᵢ . . . TRₙ whose value lies between T1 and T2, and
a step 270 of measuring the defect rate and the thicknesses at the centre and at the edges of each of the reference components Pr1 . . . Prn.

In this way a reference table is constructed. This reference table shows critical dimensions such as the thickness at the centre, the thicknesses at the edges, and the defect rate, measured in correspondence with the temperatures TRi to TRn. The value of the threshold temperature Ts corresponds to the temperature chosen from TRi . . . TRn that shows the smallest difference between the thickness at the centre of the component and the thickness of the edges of the component (the smallest “edge effect”) while conforming to the specified defect rate Vd.

According to a variant embodiment, expansion measurements are made on a series of preliminary composite components subjected to a thermal cycle, in order to define a range of test temperatures, before step 220. These expansion measurements may also be made on the reference components PR1 . . . PRn.

By way of example, for a preliminary component 10 in which the resin is an epoxy resin, the threshold temperature Ts is 100° C., and the applied pressure is 7.5 bars.

Clearly, the present invention is not limited to the embodiment described above, but may be extended to any variant which conforms to its principle.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a composite component from a plurality of plies of fibres embedded in a resin, the method comprising:
forming a preliminary component by draping the plurality of fibre plies in a mould;
laying up the preliminary component;
polymerizing the preliminary component arranged in an enclosure equipped with a device for measuring a temperature T inside the enclosure;
demoulding the preliminary component;
testing the dimensions and defect rate,
wherein the polymerization step comprises an application of a pressure P in the enclosure as soon as the temperature T is greater than or equal to a threshold temperature, determined by a reference table allowing for the critical dimensions of the composite component and the defect rate required for said composite component.

2. The method according to claim 1, wherein the lay-up step comprises:
laying a release fabric and edging wedges, an airtight film, a set of clamping wedges, a drainage fabric and a cover sheet on the preliminary component.

3. The method according to claim 1, wherein the lay-up step comprises: laying a piece of release fabric on a free face and on the edges of the preliminary component, the dimensions of the release fabric being greater than the dimensions of the preliminary component, so that the release fabric covers the whole of the free face, the whole of the edges of the preliminary component, and a portion of the table; and
arranging a set of edging wedges on the portion of the piece of release fabric that covers the table of the tool.
